(19) United States
(12) Patent Application Publication
(10) Pub. No.: US 2008/0016201 A1
(43) Pub. Date: Jan. 17, 2008

(54) METHODS AND APPARATUS FOR TRANSFERRING DATA

(75) Inventor: Mark Thompson, Tempe, AZ (US)

Correspondence Address: NOBLITT & GILMORE, LLC., 4800 NORTH SCOTTSDALE ROAD, SUITE 6000, SCOTTSDALE, AZ, 85251, US

(73) Assignee: Solid State Networks, Inc.

(21) Appl. No.: 11/778,544

(22) Filed: Jul. 16, 2007

Related U.S. Application Data
(60) Provisional application No. 60/807,484, filed on Jul. 15, 2006.

(51) Int. Cl. G06F 15/173

(52) U.S. Cl. 709/223

(57) ABSTRACT

Methods and apparatus for a system for transferring data according to various aspects of the present invention operate in conjunction with a network configured to transfer data files among clients of the network. A client may receive a file from network, in multiple file segments from the multiple sources. The client may assemble the file segments into a proper sequence, and provide the assembled file to the file-using program.

### CROSS-REFERENCE TO RELATED APPLICATION

This application claims the benefit of U.S. Provisional Patent Application Ser. No. 60/807,484, filed Jul. 15, 2006, entitled METHODS AND APPARATUS FOR TRANSFERRING DATA, and incorporates the disclosure of such application by reference. To the extent that the present disclosure conflicts with any referenced application, however, the present disclosure is to be given priority.

### BACKGROUND

Increasingly, the Internet and other networks are used to transfer digital media in the form of video and music files. To access these files, a user may navigate to a website that provides links to music and video files that are stored on a web server. To view or listen to those files, a user may download them directly from the web server. Servers that provide content to a large number of users must, accordingly, have sufficient bandwidth to serve those files. For many organizations, the expense of acquiring sufficient bandwidth to provide a satisfactory user experience is prohibitive.

In an effort to minimize the expense and difficulty associated with the distribution of a large amount of content through a network, various peer-to-peer (p2p) protocols and associated networks have been developed, such as BitTorrent, gnutella, Skype, etc. A p2p network distributes content through the network using the computing power and bandwidth available to the network's individual users to transfer files through the network, rather than relying entirely on the bandwidth of a single server or group of servers.

Although p2p networks permit distribution of large files, they are generally not effective at distributing streaming content, such as streaming video, music or other forms of streaming media. To distribute a file, p2p clients usually split the file into segments that are then individually distributed amongst the users of the network. These file segments can then be retrieved by a single user from multiple sources in the p2p network. After they are all downloaded, the file segments are then combined to re-create the original file. Unfortunately, the segments are not usually downloaded sequentially—often the client downloads the latter portions of a file before earlier portions. Consequently, a movie or music file can only be viewed after the entire file download is complete, which may inhibit streaming.

Although p2p networks can be very efficient at distributing large files, they also tend to require significant amounts of spool-up time before they reach maximum file transfer rates. When a file is first available via a p2p network, substantial communication must occur between the various members of the p2p network before file segment transfers can take place. As a result, the transfer rate for a particular file may be substantially diminished when the file is first introduced to a p2p network.

### SUMMARY OF THE INVENTION

Methods and apparatus for a system for transferring data according to various aspects of the present invention operate in conjunction with a network configured to transfer data files among clients of the network. A client may receive a file from network, in multiple file segments from the multiple sources. The client may assemble the file segments into a proper sequence, and provide the assembled file to the file-using program.

### BRIEF DESCRIPTION OF THE DRAWING FIGURES

Representative elements, operational features, applications and/or advantages of the present invention reside in the details of construction and operation as more depicted, described and claimed. Reference is made to the accompanying drawings, wherein like numbers typically refer to like parts.

FIG. 1 is a block diagram of a system for transferring data according to various aspects of the present invention; and

FIG. 2 is a flow diagram of a system for transferring data according to various aspects of the present invention.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present invention.

Representative elements, operational features, applications and/or advantages of the present invention reside in the details of construction and operation as more fully hereafter described or otherwise identified. The description may refer to the accompanying drawings, images, figures, etc., wherein like numerals (if any) refer to like parts throughout. Elements, operational features, applications and/or advantages are illustrated by certain exemplary embodiments recited in the disclosure herein.

Elements in the figures, drawings, images, etc. are illustrated for simplicity and clarity and have not necessarily been drawn to scale. For example, the dimensions of some of the elements in the figures may be exaggerated relative to other elements to help improve understanding of various embodiments of the present invention. Furthermore, the terms ‘first’, ‘second’, and the like herein, if any, are used for distinguishing between similar elements and not necessarily for describing a sequential or chronological order. Moreover, the terms ‘front’, ‘back’, ‘top’, ‘bottom’, ‘over’, ‘under’, and the like in the disclosure and/or in the exemplary embodiments, if any, are generally employed for descriptive purposes and not necessarily for comprehensively describing exclusive relative position. Any of the preceding terms so used may be interchanged under appropriate circumstances such that various embodiments of the invention, for example, are capable of operation in other configurations and/or orientations than those explicitly illustrated or otherwise described.

### DETAILED DESCRIPTION OF EXEMPLARY EMBODIMENTS

The present descriptions relate to exemplary embodiments of the invention and the inventor's conception of the best mode and are not intended to limit the scope, applicability or configuration of the invention in any way. Instead, the following description is intended to provide convenient illustrations for implementing various embodiments of the invention. Changes may be made in the function and/or arrangement of any of the elements described in the disclosed exemplary embodiments without departing from the spirit and scope of the invention.

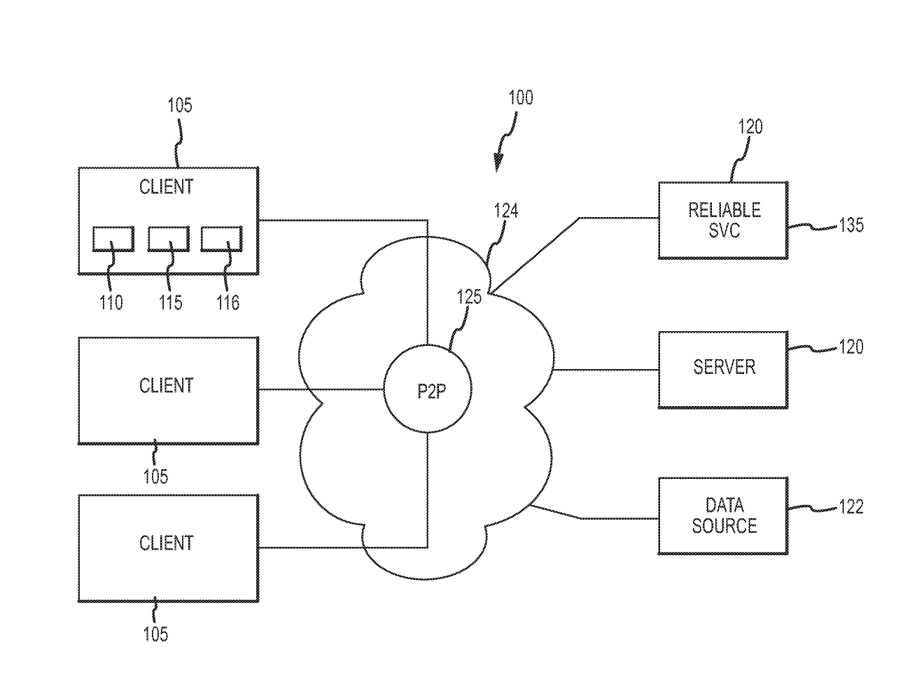

Referring to FIG. 1, a system for transferring data 100 according to various aspects of the present invention may function with multiple computers exchanging data. For example, the present exemplary system for transferring data 100 operates in conjunction with multiple clients 105 connected to each other and/or one or more remote servers 120 and/or other data sources 122 via a medium 124. Data is transferred among the various clients 105, servers 120, and/or other data sources 122 via the communications medium 124.

The medium 124 facilitates the transfer of information, and may comprise any suitable medium for transferring information. For example, the medium 124 may comprise the Internet, a local area network or any other suitable wired or wireless communications network. In the present embodiment, the medium 124 may include a p2p network 125 comprising multiple devices configured to exchange information, such as using a BitTorrent protocol to distribute digital files. The p2p network 125 may, however, comprise a network of computers using alternative systems for communicating and distributing data or files via the medium 124, such as Microsoft's Avalanche system, Skype, Gnutella, Napster, or any other appropriate data or file distribution system.

Any appropriate systems and devices may be connected to the p2p network 125, such as clients 105, computers, entertainment systems, data sources 122, and servers 120. In the present embodiment, one or more data sources 122 may be connected to the p2p network 125 and provide data, for example in response to requests. The data sources 122 may comprise any suitable systems for providing data, such as a local storage media, networked storage systems and computers, web servers, databases, loopback network interfaces, cameras, PDAs, televisions, radios, and/or other recording or audiovisual systems, and the like.

In addition, the present embodiment may include one or more servers 120 that may operate as data sources 122 and provide other appropriate functions. The servers 120 may comprise any suitable computer systems or other electronic devices configured to communicate via the medium 124. For example, the servers 120 may comprise hardware, software, and/or networking components configured to receive and process requests from the clients 105 and provide a suitable website or other Internet-based user interface which is accessible by the clients 105. In one embodiment , the server 120 comprises a convention networked computer server running an operating system, such as Microsoft Windows, Mac OSX, or Linux, and a web server, such as an Apache web server. The server 120 may comprise a daemon or software application, a physical computer that is connected to a network, and/or a combination of software and hardware.

In one embodiment, the system for transferring data 100 includes one or more reliable service servers 135. The reliable service server 135 may comprise a reliable resource for obtaining information via the p2p network 125 when such information is otherwise difficult to retrieve. For example, the reliable service server 135 may be configured to maintain a copy of a large portion, such as substantially all, of the content available via the p2p network. The reliable service server 135 may also comprise a highly reliable system that is consistently available to other network elements. Thus, in the event that a file or file segment cannot be readily retrieved from other network resources, the client 105 may access the reliable service server 135 to acquire the missing information. By doing so, the reliable service server 135 may improve file availability in the event of lower file segment availability from the other elements of the p2p network 125 and otherwise minimize the degradation of file transfer rate associated with the p2p network 125.

The reliable service server 135 may transmit data to the translation server 115, client application 110, or media player 116. The reliable service server 135 may comprise any system to receive and process requests from the client 105 that provides reliable availability of desired files, such as a high-reliability server providing a suitable website or other Internet-based user interface which is accessible by the client 105, client application 110, media player 116 or the translation server 115 via the medium 124. For example, the reliable service server 135 may comprise a computer running an operating system and a web server. Data may be retrieved from the reliable service server 135 in any suitable manner. For example, the reliable service server 135 may transmit data using a p2p file transfer protocol or an HTTP protocol.

When the p2p network 125 performance is degraded such that it becomes difficult to retrieve particular file segments, the translation server 115, client application 110, and/or media player 116 may retrieve the file segments directly from the reliable service server 135 to mitigate the problems associated with the p2p network's 125 performance. Thus, if files are not available from other sources on the p2p network 125, such as due to the recent introduction of the file segments to the p2p network 125, the file segments may be retrieved from the reliable service server 135. Also, when a user wishes to skip to view a different portion of the file, the reliable service server 135 may be used to mitigate performance degradation associated with downloading the new file segments from the p2p network 125, for example by providing particular file segments selected by the user that are not immediately available from the other sources in the p2p network 125.

The clients 105 may receive, store, and/or transmit information via the medium 124. The clients 105 may comprise any systems connected to a network for communicating and/or accessing data. For example, one or more clients 105 may comprise conventional computers having a processor and a memory responsive to the processor, such as RAM, hard drives, CD-ROM drives and disks, HD-DVD drives and disks, or other appropriate volatile or non-volatile memory systems. Alternatively, the client 105 may comprise a television, stereo, radio, gaming console, telephone, personal media player, digital assistant, or other network-connected device that receives digital or analog media content.

In the present embodiment, the clients 105 execute software for requesting and providing information via the medium 124. For example, each client 105 may comprise a conventional computer system that runs an operating system, such as Microsoft Windows, Mac OSX, Windows CE, Windows XP Embedded, Linux or other PC or embedded operating system, and is capable of executing software and connecting to a network. The client 105 may connect to the network in many different ways, including a network cable connection or a wireless connection. Also, the client 105 may communicate through the network using any appropriate communication protocols, such as TCP/IP, UDP, etc.

One or more of the clients 105 may operate client applications 110 to receive and/or transmit data via the medium 124. The client application 110 may comprise any software capable of requesting and/or receiving data via the medium 124. The client application 110 may also request any appropriate data, such as digital data encoded in a particular format, such as a Quick Time video file, MP3 file, PostScript file, or Microsoft Windows executable file, that may be used by the client application 110 or another application to perform tasks. For example, the client application 110 may display information on a computer screen, play sounds through a soundcard, play or patch a game, transmit data to another device such as a computer or television, download and/or otherwise prepare data for use by another application, or otherwise use downloaded data. The client application 110 may comprise, for example, a media player, a downloading program, a file-sharing program, a game, or other suitable program. In the present embodiment, the client application includes a BitTorrent client that utilizes the BitTorrent protocol or other appropriate p2p protocol for data transfer.

For example, the client application 110 may include a communication program to cause the client 105 to receive the data, format or translate the data for use by the client application 110, assemble the data into a proper sequence, and/or provide the formatted and/or assembled data to another program or portion of the communication program for use. For example, the client application 110 may comprise a web browser, and may operate in conjunction with one or more plug-in programs that interact with the web browser. The plug-in may operate as separate code from the main program, for example to read or edit specific types of files, such as to play and watch Flash presentations in the web browser.

The files may comprise any suitable collections of information collected under a particular name, such as conventional computer files. The files may include subfiles or any other appropriate structure. In addition, the information in the files may be any appropriate information, such as data for sound, video, program data, patch information, game data, or the like. In many cases, to distribute a file, the clients 105 of the p2p network 125 split a file into a series of file segments, such as in accordance with conventional BitTorrent distribution. The size of the file segments may be determined by several factors, including the performance of the medium 124 through which the clients 105 of the p2p network 125 communicate, the size of the original file, or other factors. When a client 105 wishes to retrieve a particular file from the p2p network 125, that client 105 can communicate with other clients 105 of the p2p network 125 to discover the availability of particular file segments that comprise the file. The clients 105 may then retrieve those file segments and then can combine them to recreate the original file.

The client application 110 may be configured to retrieve a p2p file description from a server 120 or other data source 122. The p2p file description describes the file and provides sufficient data such that the file may be retrieved from the p2p network 125 and/or the reliable server service 135 or other data source 122. For example, the client application 110 may retrieve a webpage from the server 120 or other data source 122 that contains an HTML tag, such as an <EMBED> tag, that instantiates a translation server 115 and a media play 116 or other file-using program and contains sufficient data for the translation server 115 to retrieve the file from the p2p network 125. In one embodiment, the translation server 115 and/or the media player 116 are implemented as browser plug-ins that interact with the main or host application.

The <EMBED> tag may include a p2p file description containing all the information that the translation server 115 requires to retrieve a file from a server 120, p2p network 125, or other source 122. Furthermore, the <EMBED> tag may include information that instructs the media player 116 or other file-using program how to retrieve and play or otherwise utilize the file as it is subsequently provided by the translation server 115. For example, for a BitTorrent network, the <EMBED> tag may describe the URL of a tracker that monitors the clients 105 that are connected to the p2p network 125 and are distributing file segments, the name of the file, the size of the file segments, the size of the file, and other information that allows the translation server 115 or client application 110 to verify the integrity of the file segments retrieved from the p2p network 125.

The file-using program may comprise any suitable system or application for using the received information. In the present embodiment, the file-using program comprises the media play 116, which may comprise a conventional program for rendering audiovisual information based on electronic data, such as an Adobe PDF reader, a Flash-based movie player, or a Windows Media Player. The file-using program may be selected according to the type of content or other appropriate criteria, and may comprise any appropriate program or system for using the received data, such as an entertainment player, a game, or other program. In addition, the file-using program may be initiated by an appropriate event, such as via a web browser plug-in or other program that initiates in response to a request to download and play a compatible file type.

The translation server 115 receives the file segments from the various network resources and provides the assembled file segments to the file-using program. The translation server 115 may comprise a software application executed by the client 105 and/or a remote computer configured to communicate with the requesting client 105. In the present embodiment, the translation server 115 comprises a program running on the requesting client 105, and may be initiated in response to a download request. For example, like the file-using program, the translation server 115 may be implemented as a a web browser plug-in or other program that initiates the translation server 115 in response to a request to download and play a compatible file type.

The p2p network 125 is suitably configured to communicate with the translation server 115 such that the translation server 115 is capable of communicating with the clients 105 and retrieving file segments from the p2p network 125.

In the present embodiment, the translation server 115 and the file-using program may be initiated in response to file information indicating that the file is in a format compatible with the file-using program and distributed via a protocol compatible with the translation server 115. For example, the EMBED tag may indicate that the associated file is distributed via BitTorrent protocols, causing the client application 110 to initiate the translation server 115 to retrieve the file segments. In addition, the EMBED tag may indicate that the file type is an Adobe PDF file, which may cause the client application 110 or the translation server 115 to initiate an Adobe PDF Reader media player 116.

The translation server 115 requests and receives the file segments according any appropriate protocols and techniques. For example, the translation server 115 may request file segments according to BitTorrent or other file distribution processes. In the present embodiment, the translation server 115 contacts a tracker identified in the EMBED tag, accesses a distributed has table, or otherwise determines network resources for requesting the relevant file segments. The translation server 115 then requests the file segments from the various identified network resources.

The translation server 115 may request file segments from the p2p network 125 according to the sequence of the file segments in the original file. By retrieving the file segments sequentially, the media player 116 can consume the file segments' contents in substantially the same order as that in which they are received. The translation server 115 may also or alternatively request the file segments according to scarcity or availability on the p2p network 125 to allow optimal time to retrieve rare file segments.

As the translation server 115 receives the file segments, the translation server 115 may assemble the file segments into a proper sequence for transmission to the file-using program for consumption. For example, the translation server 115 may assemble the file segments of a movie file into the proper sequence for playback so that the file may be streamed to the media player 116.

The files may be received in the proper sequence, and may not require assembly. If the file segments are not received in sequential order, for example due to a request sequence, varying retrieval times for different file segments and network resources, varying connection qualities to network resources, or failed communications or requests, the translation server 115 may assemble the file segments into the proper sequence before providing them to the file-using program.

As the file segments are received and assembled, some file segments may not be found. The translation server 115 may request missing file segments by searching other network resources for the missing segments. In the present embodiment, the translation server 115 requests the file segments from various network resources according to a request procedure. In the present embodiment, the request procedure is configured to reduce burdens on central resources such as the servers 120 and the reliable service server 135, but retain the ability to acquire missing file segments. For example, the translation server 115 may initially request file segments from other clients 105. If a file segment cannot be retrieved from the other clients 105, the translation server 105 may request the missing file segment from the servers 120, which may have a greater selection of file segments but slower response times. If the missing file segment remains unavailable, the translation server may request the file segment the reliable service server 135.

The translation server 115 may also translate incoming file segments into a format that can be used by the media player 116, client application 110, or other appropriate system. In the present embodiment, the translation server 15 receives the file in a first format and retransmits received file to the file-using program using an alternative transmission protocol. For example, the present translation server 115 may retrieve file segments from the p2p network 125 using the BitTorrent protocol or other suitable peer-to-peer file transfer protocol and retransmit those file segments using an HTTP protocol. The translation server 115 may retransmit the file using any other appropriate protocols, such as RTSP, FTP, DSS, or by simply providing access to a file stored on a local or network-accessible storage system.

For example, the translation server 115 may retrieve the requested information from the p2p network 125 as BitTorrent file segments and convert the data into a local HTTP stream. The media player 116 may then receive the data from the local HTTP stream as it is made available by the translation server 115. Thus, the translation server 115 may operate as a local server, such that media player 116 perceives the translation server 115 as an original source of the HTTP data. The media player 116 may receive a video stream from the local server in the same manner as a remote source, for example from http://localhost/movie_file.mov rather than http://www.website.com/movie_file.mov. Consequently, the translation server 115 is effectively transparent to the media player 116, and the media player 116 does not require specific configuration to operate with the p2p network 125 or other network resources.

The translation server 115 may provide the data in any appropriate manner, such as according to the type and availability of the downloaded data. For example, if the downloaded data comprises a non-sequential collection of data, such as a software program that cannot be executed until all elements are downloaded, the translation server 115 may retain the data until the file has been fully received and assembled, or may retransmit the data substantially immediately for assembly and/or use by the media player 116 when all of the file segments have been received. If the data comprises a sequential presentation, the translation server 115 may retransmit data in the appropriate sequence as the relevant file segments are received. If the data is available, the information contained within the downloaded file segments may be retransmitted by the translation server 115 in approximately real-time, such that data is retransmitted generally as it becomes available. Thus, the translation server may begin streaming the data to the file-using program before the entire file has been received. Alternatively, retransmission may be delayed as determined by the requirements of the client application 110, user preferences, or other pre-determined input. The translation server 115 may also perform any other appropriate tasks to make the data useable by the media player 116, such as processing interactions with the media player 116.

To retrieve data for usage by the client 105, the client application 110 requests a particular file. In response, the system for transferring data 100 transmits the segments of the file to the client 105. As the file segments are received, the client application 110 may prepare the files for usage. For example, the translation server 115 may receive the file segments and provide the file segments to the media player 116 as a local server. In addition, the translation server 115 may sequence, translate, and/or format the file segments for use by the media player 116.

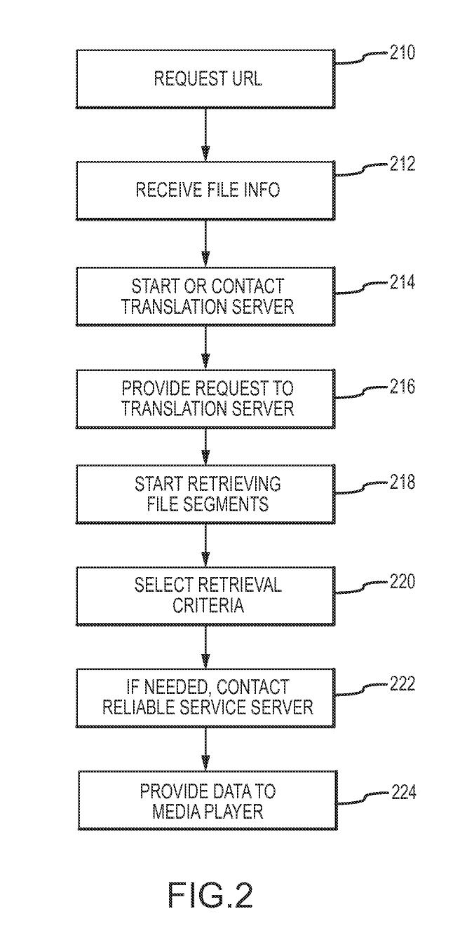

More particularly, the system for transferring data 100 may transfer information in response to a request initiated by the client application 110. The request may comprise a communication from a client application 110 requesting a particular file or information describing a file and how to retrieve the file from a p2p network 125. For example, referring to FIG. 2, a web browser operating on the client 105 may request data from a URL one of the servers 120 (210). The URL may refer to a webpage and correspond to a file to be retrieved, such as a file that contains text and HTML tags, an executable file or script that the server 120 runs and whose output may be transmitted to the client software application 110, or a file that contains data.

In addition, the URL may point the client application 110 to a source for downloading the file, such as in accordance with a BitTorrent protocol. In the present embodiment, the URL provides the p2p file description, which identifies one or more trackers to identify network resources, such as clients 105, servers 120, and/or reliable service servers 135, from which the file may be retrieved. The client application 110 may then request the file segments from the various identified network resources.

The client application 110 may retrieve any type of data from the server 120 (212). In the present embodiment, the client 103 may receive file data, such as an HTML tag, containing a description of the information to be retrieved. The file data may contain a p2p file description, for example using an <EMBED> tag. The p2p file description may include file size, file name, file type, file encoding information, local storage location and any other information that may be used to retrieve the file from the p2p network 125.

In response to the file data, the client 105 may initiate the translation server 115 (214) to request the file segments, translate the file segments into a format for the media player 116, and/or supply the file segments to the file-using program for use. In the present embodiment, the web browser initiates the translation server 115 in response to the file data, such as an indication that the file may be retrieved via the p2p network using BitTorrent protocols. Alternatively, the translation server 115 may already be running, for example in conjunction with a translation server 115 that is continuously running, started by a user, or otherwise initiated. The translation server 115 may be initiated by any appropriate system, such as the client application 110 or the media player 116. The client 105 may also initiate the appropriate file-using program, such as the media player 116, according to the type of data contained in the files to be received.

In response to the requests, the various network resources provide the file segments to the client application 110. For example, the client application 110 may notify the translation server 115 of the data request (216) and provide to the translation server 115 the p2p file description that identifies the file to be retrieved and also contains sufficient information to retrieve the file from the p2p network 125. Upon receiving sufficient information from client application 100, the translation server 115 may communicate with the p2p network 125 and begin retrieving segments of the specified file, for example in accordance with the information in the <EMBED> tag (218). The translation server 115 suitably locates file segments made available by the various clients 105 of the p2p network 125, performs peer negotiation to acquire the file segments, and verifies the integrity of received files.

The file segments may be retrieved according to any appropriate criteria, such as the type of file being retrieved, p2p network 125 performance, and/or requirements of the client application 110 or media player 116 (220). For example, when downloading non-streaming data or other data that will not be accessed immediately as it is received, such as game data or still-image data, the translation server 115 may seek file segments according to scarcity to download those file segments that are the least available in the p2p network 125 before other file segments that are more widely available. On the other hand, when the client application 110 requests streaming data, such as video, music, or other suitable files for immediate sequential presentation or execution, the user or application may wish to begin accessing the file as soon as possible. In such circumstances, when requesting data from the p2p network 125, the translation server 115 may employ a file segment selection algorithm that selects substantially sequential file segments to initially retrieve file segments from the beginning of the file before those nearer the end of the file. The translation server 113 places priority on acquiring file segments that are to be used earlier on in the stream.

If the requested file segments are not readily available from the p2p network 125, the translation server 115, client application 110, and/or media player 116 may request missing file segments from one of the reliable service servers 133 (222). For example, if the clients 105 in the p2p network 125 do not have the relevant file segments, or if sufficient bandwidth is unavailable for a client 105 or other network resource having the file segment to transfer the file segments within a desired timeframe, the translation server 115 may stall the download process to find the file segment on another client 105 or one or more reliable service servers 135. If the file segments are found, the file segments are requested, if not, the translation server 115 may generate an error message indicating that the file or file segment was not found.

As the requested file segments are received, the translation server 115 may make the data contained within those file segments available to the client application 110 and/or the media player 116. For example, the translation server 115 may retrieve all file segments associated with a particular file. After retrieving all file segments, the translation server 115 may assemble file segments so as to reconstruct the original file and then make that file available to the file-using program, such as the client application 110 or media player 116. For example, if the original file were a movie file, the translation server 115 may recombine the file segments so as to form the original movie file and then may make the file available to the media player 116.

The translation server 115 may make the file available to the media player 116 using any suitable method. For example, the translation server 115 may provide a HTTP stream of the contents of the movie file. Alternatively, the translation server 115 may communicate the contents of the movie file to the media player 116 using RTSP, FTP, DSS, or by simply providing access to a file stored on a local or network-accessible storage system.

The media player 116 receives the data for use, such as playback, gameplay, or storage. In the present embodiment, as the translation server 115 receives the requested file segments, the translation server 115 provides an HTTP stream of the available file contents that the client application 110, media player 116, and/or other file-using program may access (224). If the translation server 115 is running on the client 105, the HTTP file stream may be available at a local location, such as http://localhost/movie_file.mov. Thus, the media player 116 receives the data from the translation server 115, which operates as a local HTTP server providing streamed data.

In some case, the file being retrieved from the p2p network 125 may be suitable for streaming prior to receiving all of the file segments that comprise the original file. In such a case, the translation server 115 may retrieve the file segments of the original file from the various clients 105 of the p2p network 125 at least partially sequentially. Upon retrieving file segments from the p2p network 125, the translation server 115 may recombine the file segments in real time and make the file contents available to the media player 116. For example, if the file to be retrieved from the p2p network 125 is suitable for streaming, the translation server 115 may retrieve some of the file segments from the p2p network 125, assemble those file segments to create a portion of the original file, and then stream the available file contents to the media player 116 or other suitable client application 110. As additional file segments are retrieved from the p2p network 125, they can be further assembled to the retrieved portion of the original file and made available for streaming. The time at which the translation server 115 can begin streaming the file contents to the client application 110 or media player 116 and the amount of data that may be communicated through the stream may depend upon several factors, such as the rate at which file segments are retrieved from the p2p network, the size of the file segments, the rate at which data is consumed by the media player 116 or client application 110, and to what degree the order of the file segments retrieved from the p2p network 125 approximates their original sequence in the file being retrieved.

A user, client application 110, or media player 116 may wish to access a file at a selected location, such as to jump to the middle of a video or music file. If the translation server 115 is providing a stream of the file contents only as they become available, the media player 116 or client application 110 may be attempting to access a portion of the file that the translation server 115 has not yet retrieved from the p2p network 125. In such a case, the translation server 115 may stall the stream of data flowing from the translation server 115 to the media player 116 or client application 110 while it retrieves the file segments that are necessary to begin streaming the file at the requested point.

For example, if the user, client application 110 or media player 116 wishes to jump forward within a movie file that is being retrieved from an HTTP stream provided by the translation server 115, the translation server 115 may temporarily stall the HTTP file stream while it waits to download from the p2p network 125 those file segments that correspond to the portion of the file that the user wishes to view. In some situations, there may a delay associated with retrieving the newly selected file segments from the p2p network 125. The delay may be due to overhead associated with requesting the new file segments from the plurality of clients 105 connected to the p2p network 125 or other causes. If the retrieval of the newly requested file segments is so delayed or as other performance considerations require, the translation server 115, the media player 116 or the client application 110 may connect to one or more of the reliable server servers 135 or other data sources 122 to retrieve those segments that are delayed.

In the foregoing specification, the invention has been described with reference to specific exemplary embodiments; however, various modifications and changes may be made without departing from the scope of the present invention as set forth in the exemplary embodiments. The specification and figures are to be regarded in an illustrative manner, rather than a restrictive one and all such modifications are intended to be included within the scope of the present invention. For example, the steps recited in any method or process embodiments may be executed in any appropriate order and are not limited to the specific order presented in the exemplary embodiments. Additionally, the components and/or elements recited in the apparatus embodiments may be assembled or otherwise operationally configured in a variety of permutations to produce substantially the same result as the present invention and are accordingly not limited to the specific configuration recited in the exemplary embodiments.

Benefits, other advantages and solutions to problems have been described above with regard to particular embodiments, however, any benefit, advantage, solution to problems or any element that may cause any particular benefit, advantage or solution to occur or to become more pronounced are not to be construed as critical, required or essential features or components of any or all the exemplary embodiments.

As used herein, the terms “comprises”, “comprising”, “including”, or any variation thereof, are intended to reference a non-exclusive inclusion, such that a process, method article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A computer system configured to connect to a p2p network having multiple sources and utilize a file via a file-using program, comprising:
a processor having access to the p2p network; and
a memory responsive to the processor, wherein the memory stores a p2p communication program configured to cause the computer system to:
receive the file from the p2p network, wherein receiving the file comprises receiving multiple file segments from the multiple sources;
assemble the file segments into a proper sequence; and
provide the assembled file to the file-using program.

2. A computer system according to claim 1, wherein the file-using program comprises a media player program.

3. A computer system according to claim 2, wherein the p2p communication program comprises a local server configured to provide the assembled file segments to the file-using program.

4. A computer system according to claim 1, wherein the p2p communication program is further configured to request the file from the p2p network.

5. A computer system according to claim 4, wherein the p2p communication program is configured to request the file segments according to a playback sequence of the file segments.

6. A computer system according to claim 4, wherein the p2p communication program is configured to request the file segments according to a rarity of the file segments.

7. A computer system according to claim 1, wherein:
the file segments are BitTorrent file segments; and
the p2P communication program is configured to receive the file from a BitTorrent network.

8. A computer system according to claim 1, wherein the p2p communication program comprises a browser plug-in.

9. A method for transferring a file via a p2p network connected to multiple sources for use by a file-using program, comprising:
receiving the file from the p2p network as multiple file segments from the multiple sources;
assembling the file segments into a proper sequence; and
providing the assembled file to the file-using program.

10. A method for transferring a data file according to claim 9, wherein the file-using program comprises a media player program.

11. A method for transferring a data file according to claim 10, wherein providing the assembled file comprises providing the assembled file via a local server to the media player program.

12. A method for transferring a data file according to claim 9, further comprising requesting the file segments from the p2p network.

13. A method for transferring a data file according to claim 12, wherein requesting the file segments comprises requesting the file segments according to a playback sequence of the file segments.

14. A method for transferring a data file according to claim 12, wherein requesting the file segments comprises requesting the file segments according to a rarity of the file segments.

15. A method for transferring a data file according to claim 12, wherein requesting the file segments comprises requesting the file segments in response to a web browser program.

16. A method for transferring a data file according to claim 9, wherein the file segments are torrent files, further comprising receiving the file segments from a BitTorrent network.

17. A method for transferring a data file according to claim 9, further comprising initiating a trthe p2p communication program comprises a browser plug-in.

18. A medium storing computer-executable instructions, wherein the instructions are configured to cause a computer configured to run a file-using program and connected to a p2p network having multiple resources to:
receive a file from the p2p network, wherein receiving the file comprises receiving multiple file segments from the multiple sources;
assemble the file segments into a proper sequence; and
provide the assembled file to the file-using program.

19. A medium according to claim 18, wherein the file-using program comprises a media player program.

20. A medium according to claim 19, wherein the p2p communication program comprises a local server configured to provide the assembled file segments to the file-using program.

21. A medium according to claim 18, wherein the p2p communication program is further configured to request the file from the p2p network.

22. A medium according to claim 21, wherein the p2p communication program is configured to request the file segments according to a playback sequence of the file segments.

23. A medium according to claim 21, wherein the p2p communication program is configured to request the file segments according to a rarity of the file segments.

24. A medium according to claim 18, wherein:
the file segments are BitTorrent file segments; and
the p2p communication program is configured to receive the file from a BitTorrent network.

25. A medium according to claim 18, wherein the p2p communication program comprises a browser plug-in.

26. A computer program configured to cause a computer configured to run a file-using program and connected to a p2p network having multiple resources to:
receive a file from the p2p network, wherein receiving the file comprises receiving multiple file segments from the multiple sources;
assemble the file segments into a proper sequence; and
provide the assembled file to the file-using program.

27. A computer program according to claim 26, wherein the file-using program comprises a media player program.

28. A computer program according to claim 27, wherein the p2p communication program comprises a local server configured to provide the assembled file segments to the file-using program.

29. A computer program according to claim 26, wherein the p2p communication program is further configured to request the file from the p2p network.

30. A computer program according to claim 29, wherein the p2p communication program is configured to request the file segment according to a playback sequence of the file segments.

31. A computer program according to claim 29, wherein the p2p communication program is configured to request the file segments according to a rarity of the file segments.

32. A computer program according to claim 26, wherein:
the file segments are BitTorrent file segments; and
the p2p communication program is configured to receive the file from a BitTorrent network.

33. A computer program according to claim 26, wherein the p2p communication program comprises a browser plug-in.
